(19) United States
(12) Patent Application Publication
(10) Pub. No.: US 2026/0103484 A1
(43) Pub. Date: Apr. 16, 2026

(54) TRANSITION METAL COMPOUND, CATALYST COMPOSITION COMPRISING THE SAME, AND METHOD FOR PREPARING OLEFIN POLYMER USING THE SAME

(71) Applicant: SABIC SK Nexlene Company Pte. Ltd., Singapore (SG)

(72) Inventors: Dongcheol Shin, Daejeon (KR); Yeonock Oh, Daejeon (KR); Minji Kim, Daejeon (KR); Wonwoo Park, Daejeon (KR); Sang Bae Cheong, Daejeon (KR); Dongkyu Park, Daejeon (KR); Choon Sik Shim, Daejeon (KR); Minho Jeon, Daejeon (KR); Dae Ho Shin, Daejeon (KR)

(21) Appl. No.: 19/116,295

(22) PCT Filed: Jul. 21, 2023
(86) PCT No.: PCT/IB2023/057435

§ 371 Date: Mar. 27, 2025

(30) Foreign Application Priority Data
Sep. 30, 2022 (KR) 10-2022-0124841
Jul. 20, 2023 (KR) 10-2023-0094346

(51) Int. Cl. C07F 17/00; C08F 4/659; C08F 210/16

(52) U.S. Cl. CPC C07F 17/00; C08F 4/65912; C08F 210/16

(57) ABSTRACT

Provided are a novel transition metal compound, a transition metal catalyst composition for preparing an olefin polymer including the same, and a method for preparing an olefin polymer using the same. The transition metal compound according to one implementation has drastically improved solubility in a hydrocarbon-based solvent by introducing a carbazole substituent, and may maintain excellent catalytic activity without deterioration during solution polymerization. Besides, injection, movement, and the like of the transition metal compound are easily performed during a solution process to drastically improve a polymerization process, which may be very favorable for commercialization.

### TECHNICAL FIELD

The present disclosure relates to a transition metal compound, a catalyst composition comprising the same, and a method for preparing an olefin polymer using the same, and more particularly, to a transition metal compound having improved solubility by introducing a specific functional group, a catalyst composition comprising the same, and a method for preparing an olefin polymer using the same.

### BACKGROUND ART

Conventionally, in the preparation of a homopolymer of ethylene and copolymers of ethylene and α-olefins, a Ziegler-Natta catalyst system comprising a main catalyst component of a titanium or vanadium compound and a cocatalyst component of an alkyl aluminum compound has been generally used. However, though the Ziegler-Natta catalyst system represents high activity to ethylene polymerization, it has a demerit in that a produced polymer generally has a broad molecular weight distribution due to a heterogeneous catalytic active site, and in particular, copolymers of ethylene and α-olefins have a non-uniform composition distribution.

Recently, a so called, metallocene catalyst system comprising a metallocene compound of Group 4 transition metals in the periodic table, such as titanium, zirconium and hafnium, and methylaluminoxane as a cocatalyst has been developed. Since the metallocene catalyst system is a homogeneous catalyst having a single species of catalyst active site, it is characterized by preparing polyethylene having a narrow molecular weight distribution and a uniform composition distribution as compared with the conventional Ziegler-Natta catalyst system. As a specific example, a metallocene compound such as Cp₂TiCl₂, Cp₂ZrCl₂, Cp₂ZrMeCl, Cp₂ZrMe₂, and IndH_{4 2}ZrCl₂ is activated by methylaluminoxane as a cocatalyst to polymerize ethylene with high activity, thereby preparing polyethylene having a narrow molecular weight distribution (Mw/Mn).

However, it was difficult to obtain a high molecular weight polymer with the metallocene catalyst system, and in particular, when the metallocene catalyst system is applied to a solution polymerization method which is carried out at a high temperature of 100° C. or higher, polymerization activity is rapidly reduced and a β-dehydrogenation reaction dominates, and thus, the metallocene catalyst system is not appropriate for preparing a high molecular weight polymer having a high weight average molecular weight (Mw).

Meanwhile, it is known that a so called, constrained geometry ANSA-type met-allocene-based catalyst to which the transition metal is connected in a ring form may be used as a catalyst which allows preparation of a high molecular weight polymer with high catalytic activity in homopolymerization of ethylene or copolymerization of ethylene and α-olefin under solution polymerization conditions of 100° C. or higher. The ANSA-type metallocene-based catalyst has extremely improved octene-injection and activity at a high temperature as compared with a metallocene catalyst. However, most of the previously known ANSA-type metallocene-based catalysts comprise a Cl functional group or comprise a methyl group and the like, and has problems to be improved for use in a solution process.

Since the Cl functional group substituted in the catalyst may cause corrosion and the like depending on the material of the process, an ANSA-type metallocene-based catalyst substituted with dimethyl was studied for avoiding the problem of corrosion by Cl, but it also has poor solubility and it is difficult to inject the catalyst to a polymerization process. Toluene, xylene, or the like may be used for dissolving the catalyst having low solubility, but when products which are likely to come into contact with foods are produced, use of an aromatic solvent such as toluene or xylene is problematic.

Accordingly, there is an urgent need for a study of a competitive catalyst having excellent solubility, activity at a high temperature, reactivity with higher α-olefin, and preparation ability of high molecular weight polymers.

### DISCLOSURE OF INVENTION

### Technical Problem

An object of the present disclosure is to provide a transition metal compound which has excellent solubility and activity at a high temperature and allows preparation of high molecular weight polymers, and a catalyst composition comprising the same.

Another object of the present disclosure is to provide a method for preparing an olefin polymer using the transition metal compound according to the implementation as a catalyst.

### Solution to Problem

In one general aspect, a transition metal compound represented by the following Chemical Formula 1A is provided:

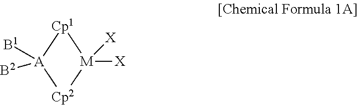

wherein
M is a Group 4 transition metal in the periodic table;
A is carbon or silicon;
Cp¹ and Cp² are independently of each other cyclopentadienyl, indenyl, or fluorenyl; and the cyclopentadienyl, the indenyl, and the fluorenyl may be substituted by any one or more selected from the group consisting of (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, and (C6-C20)arylsilyl;
B¹ and B² are independently of each other (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, or (C6-C20)arylsilyl; and
X is independently of each other represented by the following Chemical Formula 2A:

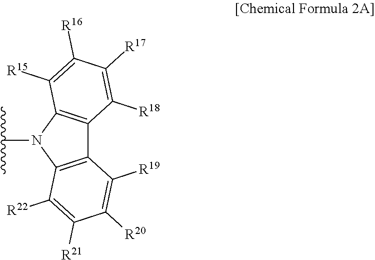

wherein
R¹⁵ to R²² are independently of one another hydrogen, (C1-C30)alkyl, (C1-C30)alkylsilyl, (C1-C30)alkoxy, (C3-C30) cycloalkyl, (C6-C30)aryl, (C6-C30)aryl(C1-C30)alkyl, or (C1-C30)alkyl(C6-C30)aryl; the alkyl, the alkylsilyl, the alkoxy, the cycloalkyl, the aryl, the arylalkyl, and the alkylaryl of R¹⁵ to R²² may be substituted by any one or more selected from the group consisting of halogen, (C1-10)alkyl, (C1-10)alkylamino, (C1-C10)alkoxy, and (C1-C10)alkylsilyl; or R¹⁵ to R²² may be connected by (C3-C12)alkylene or (C3-C12)alkenylene with or without a fused ring between adjacent substituents to form an alicyclic ring or an aromatic ring; and the alicyclic ring and the aromatic ring may be substituted by any one or more selected from the group consisting of (C1-C20)alkyl, (C1-C20)alkoxy, (C1-C20)alkoxy (C1-C20)alkyl, (C6-C20)aryl, (C6-C20)aryl(C1-C20)alkyl, (C1-C20)alkyl(C6-C20)aryl, (C1-C20)alkylsilyl, and (C6-C20)arylsilyl.

In another general aspect, a transition metal catalyst composition for preparing an olefin polymer comprises: the transition metal compound according to the implementation and a cocatalyst.

In still another general aspect, a method for preparing an olefin polymer comprises: subjecting an olefin monomer to solution polymerization under the transition metal compound according to the implementation, a cocatalyst, and a hydrocarbon-based solvent to obtain an olefin polymer.

### Advantageous Effects of Invention

The present disclosure relates to a novel transition metal compound, a transition metal catalyst composition for preparing an olefin polymer comprising the same, and a method for preparing an olefin polymer using the same. The transition metal compound according to one implementation has drastically improved solubility in a hydrocarbon-based solvent by introducing a carbazole functional group, and may maintain excellent catalytic activity without deterioration during solution polymerization. Besides, injection, movement, and the like of a transition metal compound are easily performed during a solution process to efficiently improve a polymerization process, which may be very favorable for commercialization.

In addition, since the transition metal compound according to one implementation has excellent solubility in a hydrocarbon-based solvent and has excellent reactivity with an olefin monomer, when the transition metal compound is used as a catalyst, olefin polymerization may be performed very easily, and thus, an olefin polymer may be prepared in a high yield using the compound.

In addition, the method for preparing an olefin polymer according to one implementation uses a transition metal compound having excellent solubility in a hy-drocarbon-based solvent as a main catalyst, so that transfer, injection, and the like of a catalyst are easily performed and more environmentally friendly to allow for efficient preparation of the olefin polymer.

### BEST MODE FOR CARRYING OUT THE INVENTION

Since the embodiments described in the present specification may be modified in many different forms, the technology according to one implementation should not be limited to the embodiments set forth herein. Furthermore, throughout the specification, unless otherwise particularly stated, the word “comprise”, “equipped”, “contain”, or “have” does not mean the exclusion of any other constituent element, but means further inclusion of other constituent elements, and elements, materials, or processes which are not further listed are not excluded.

The numerical range used in the present specification comprises all values within the range comprising the lower limit and the upper limit, increments logically derived in a form and spanning of a defined range, all double limited values, and all possible com-binations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present. Unless otherwise defined in the present specification, values which may be outside a numerical range due to experimental error or rounding off of a value are also comprised in the defined numerical range.

Hereinafter, unless otherwise particularly defined in the present specification, “about” may be considered as a value within 30%, 25%, 20%, 15%, 10%, or 5% of a stated value.

Hereinafter, unless otherwise specifically defined in the present specification, a singular form may be considered to comprise a plural form as well.

The terms “substituent”, “radical”, “group”, “moiety”, and “fragment” described in the present specification may be used interchangeably.

“Alkyl” described in the present specification refers to a saturated straight chain or branched chain acyclic hydrocarbon having 1 to 30 carbon atoms, unless the number of carbons is not particularly defined. Representative saturated straight chain alkyl comprises methyl, ethyl, n-propyl, n-butyl, n-pentyl, n-hexyl, n-heptyl, n-octyl, n-nonyl, and n-decyl, but saturated branched chain alkyl comprises isopropyl, sec-butyl, isobutyl, tert-butyl, isopentyl, 2-methylhexyl, 3-methylbutyl, 2-methylpentyl, 3-methylpentyl, 4-methylpentyl, 2-methylhexyl, 3-methylhexyl, 2-methylpentyl, 3-methylpentyl, 4-methylpentyl, 2-methylhexyl, 3-methylhexyl, 4-methylhexyl, 5-methylhexyl, 2,3-dimethylbutyl, 2,3-dimethylpentyl, 2,4-dimethylpentyl, 2,3-dimethylhexyl, 2,4-dimethylhexyl, 2,5-dimethylhexyl, 2,2-dimethylpentyl, 2,2-dimethylhexyl, 3,3-dimethylpentyl, 3,3-dimethylhexyl, 4,4-dimethylhexyl, 2-ethylpentyl, 3-ethylpentyl, 2-detylhexyl, 3-ethylhexyl, 4-ethylhexyl, 2-methyl-2-ethylpentyl, 2-methyl-3-ethylpentyl, 2-methyl-4-ethylpentyl, 2-methyl-2-ethylhexyl, 2-methyl-3-ethylhexyl, 2-methyl-4-ethylhexyl, 2,2-diethylpentyl, 3,3-diethylhexyl, 2,2-diethylhexyl, and 3,3-diethylhexyl.

In the present specification, when “C1-C30” is described, it means that the number of carbon atoms is 1 to 30. For example, (C1-C30)alkyl refers to alkyl having 1 to 30 carbon atoms.

“Alkenyl” described in the present specification refers to a saturated straight chain or branched chain acyclic hydrocarbon having 2 to 20 carbon atoms and at least one carbon-carbon double bond unless the number of carbons is not particularly defined. Representative straight chain and branched chain alkenyl comprises-vinyl, -allyl, -1-butenyl, -2-butenyl, -isobutylenyl, -1-pentenyl, -2-pentenyl, -3-methyl-1-butenyl, -2-methyl-2-butenyl, -2,3-dimethyl-2-butenyl, -1-hexenyl, -2-hexenyl, -3-hexenyl, -1-heptenyl, -2-heptenyl, -3-heptenyl, -1-octenyl, -2-octenyl, -3-octenyl, -1-nonenyl, -2-nonenyl, -3-nonenyl, -1-decenyl, -2-decenyl, and -3-decenyl. The alkenyl group may be selectively substituted. Alkenyl comprises a cis- and trans-oriented, or alternatively, E- and Z-oriented radical.

The term “alkoxy” described in the present specification refers to —O-(alkyl) comprising —OCH₃, —OCH₂CH₃, —O(CH₂)₂CH₃, —O(CH₂)₄CH₃, —O(CH₂) ¿CH₃, —O(CH₂)₅ CH₃, and the like, in which alkyl is as defined above.

“Alkylene” and “alkenylene” described in the present specification refers to a divalent organic radical derived by removing one hydrogen from “alkyl” and “alkenyl”, in which the definitions of alkyl and alkenyl follow the above.

The term “cycloalkyl” described in the present specification refers to a monocyclic or polycyclic saturated ring which has carbon and hydrogen atoms and no carbon-carbon multiple bond. An example of a cycloalkyl group comprises (C3-C10) cycloalkyl, for example, cyclopropyl, cyclobutyl, cyclopentyl, cyclohexyl, and cycloheptyl, but is not limited thereto. The cycloalkyl group may be selectively substituted. In an embodiment, the cycloalkyl group is a monocyclic or bicyclic ring.

“Aryl” described in the present specification is an organic radical derived from an aromatic hydrocarbon by removal of one hydrogen, comprises a monocyclic or fused ring system containing appropriately 4 to 7, 5, or 6 ring atoms in each ring, and even comprises a form in which a plurality of aryls are connected by a single bond. The fused ring system may comprise an aliphatic ring such as saturated or partially saturated rings, and necessarily comprises one or more aromatic rings. In addition, the aliphatic ring may contain nitrogen, oxygen, sulfur, carbonyl, and the like in the ring. The specific example of the aryl radical comprises phenyl, naphthyl, biphenyl, indenyl, fluorenyl, phenanthrenyl, anthracenyl, triphenylenyl, pyrenyl, chrysenyl, naphthacenyl, 9,10-dihydroanthracenyl and the like, but is not limited thereto.

“Aryloxy” described in the present specification refers to an —O-aryl radical, in which “aryl” is as defined above.

Specific examples of “alkylsilyl” and “arylsilyl” described in the present specification comprise trimethylsilyl, triethylsilyl, t-butyldimethylsilyl, vinyldimethylsilyl, propy-Idimethylsilyl, triphenylsilyl, diphenylsilyl, phenylsilyl, and the like, but are not limited thereto.

“Alkylsiloxy” and “arylsiloxy” described in the present specification refer to an —O-alkylsilyl radical and an —O-arylsilyl radical, respectively, in which “alkyl” and “aryl” are as defined above.

“Carbazole” described in the present specification is, unless otherwise particularly defined, used in the sense of comprising the case in which a carbon site of carbazole is substituted by a substituent in a range which may be easily derived by a person with ordinary skill in the art disclosed in the present specification.

“Substituted” described in the present specification means that a hydrogen atom of a substituted part, for example, alkyl, aryl, heteroaryl, heterocycle, or cycloalkyl, is replaced by a substituent. In an embodiment, each carbon atom of a substituted group is not substituted by two or more substituents. In another embodiment, each carbon atom of the substituted group is not substituted by one or more substituents. In a keto substituent, two hydrogen atoms are substituted by oxygen which is attached to carbon by a double bond. Unless otherwise stated regarding the substituent, a case in which one or more selected from halogen, hydroxyl, lower alkyl, haloalkyl, mono- or di-alkylamino, (C1-C30)alkyl, (C1-C30)alkoxy, (C3-C30) cycloalkyl, (C6-C30)aryl, (C6-C30)aryl(C1-C30)alkyl, (C1-C30)alkyl(C6-C30)aryl, (C1-C30)alkylsilyl, (C6-C30)arylsilyl, (C6-C30)aryloxy, (C3-C30)alkylsiloxy, (C6-C30)arylsiloxy, (C1-C30)alkylamino, (C6-C30)arylamino, (C1-C30)alkylthio, (C6-C30)arylthio, (C1-C30)alkylphosphine, and (C6-C30)arylphosphine is substituted is also comprised.

An “olefin polymer” described in the present specification refers to a polymer which is prepared using an olefin in a range which is recognizable by a person skilled in the art disclosed in the present specification. Specifically, it comprises both an olefin homopolymer and a copolymer of olefins, and refers to an olefin homopolymer or a copolymer of olefin and α-olefin.

One implementation provides a transition metal compound to which a carbazole substituent is introduced and which has improved solubility and excellent thermal stability, may be useful for olefin polymerization, and is represented by the following Chemical Formula 1A:

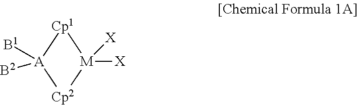

wherein
M is a Group 4 transition metal in the periodic table;
A is carbon or silicon;
Cp¹ and Cp² are independently of each other cyclopentadienyl, indenyl, or fluorenyl; and the cyclopentadienyl, the indenyl, and the fluorenyl may be substituted by any one or more selected from the group consisting of (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, and (C6-C20)arylsilyl;
B¹ and B² are independently of each other (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, or (C6-C20)arylsilyl; and
X is independently of each other represented by the following Chemical Formula 2A:

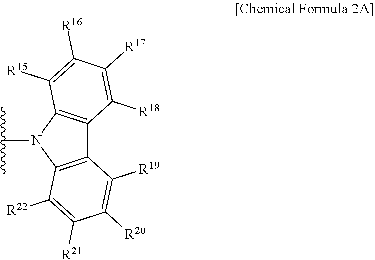

wherein
R¹⁵ to R²² are independently of one another hydrogen, (C1-C30)alkyl, (C1-C30)alkylsilyl, (C1-C30)alkoxy, (C3-C30) cycloalkyl, (C6-C30)aryl, (C6-C30)aryl(C1-C30)alkyl, or (C1-C30)alkyl(C6-C30)aryl; the alkyl, the alkylsilyl, the alkoxy, the cycloalkyl, the aryl, the arylalkyl, and the alkylaryl of R¹⁵ to R²² may be substituted by any one or more selected from the group consisting of halogen, (C1-10)alkyl, (C1-10)alkylamino, (C1-C10)alkoxy, and (C1-C10)alkylsilyl; or R¹⁵ to R²² may be connected by (C3-C12)alkylene or (C3-C12)alkenylene with or without a fused ring between adjacent substituents to form a monocyclic or polycyclic alicyclic ring or aromatic ring; and the alicyclic ring and the aromatic ring may be substituted by any one or more selected from the group consisting of (C1-C20)alkyl, (C1-C20)alkoxy, (C1-C20)alkoxy (C1-C20)alkyl, (C6-C20)aryl, (C6-C20)aryl(C1-C20)alkyl, (C1-C20)alkyl(C6-C20)aryl, (C1-C20)alkylsilyl, and (C6-C20)arylsilyl.

The transition metal compound (ANSA-type catalyst) according to an embodiment has significantly improved solubility in a hydrocarbon-based solvent, in particular, a non-aromatic hydrocarbon-based solvent and very increased catalytic activity by introducing a carbazole group represented by Chemical Formula 2A to the X site of Chemical Formula 1A, and thus, the olefin polymer may be prepared by a simple and environmentally friendly process using the transition metal compound. In addition, the olefin polymer may be easily prepared using a solution process using the transition metal compound according to an embodiment.

In an embodiment, R¹⁵ to R²² are independently of one another hydrogen, (C1-C20)alkyl, (C1-C20)alkylsilyl, (C1-C20)alkoxy, (C3-C20) cycloalkyl, (C6-C20)aryl, (C6-C20)aryl(C1-C20)alkyl, or (C1-C20)alkyl(C6-C20)aryl; the alkyl, the alkylsilyl, the alkoxy, the cycloalkyl, the aryl, the arylalkyl, and the alkylaryl of R¹⁵ to R²² may be substituted by any one or more selected from the group consisting of halogen, (C1-10)alkyl, (C1-10)alkylamino, (C1-C10)alkoxy, and (C1-C10)alkylsilyl; or R¹⁵ to R²² may be connected by (C3-C12)alkylene or (C3-C12)alkenylene with or without a fused ring between adjacent substituents to form a monocyclic or polycyclic alicyclic ring or aromatic ring; and the alicyclic ring and the aromatic ring may be substituted by any one or more selected from the group consisting of (C1-C10)alkyl, (C1-C10)alkoxy, (C1-C10)alkoxy (C1-C10)alkyl, (C6-C10)aryl, (C6-C10)aryl(C1-C10)alkyl, (C1-C10)alkyl(C6-C10)aryl, (C1-C10)alkylsilyl, and (C6-C10)arylsilyl.

Otherwise, in an embodiment, R¹⁵ to R²² may be independently of one another hydrogen, (C1-C15)alkyl, (C1-C10)alkyl, (C1-C8)alkyl, (C1-C6)alkyl, (C1-C5)alkyl, (C1-C4)alkyl, (C2-C6)alkyl, (C1-C15)alkylsilyl, (C1-C10)alkylsilyl, (C1-C8)alkylsilyl, (C1-C6)alkylsilyl, (C1-C5)alkylsilyl, (C1-C4)alkylsilyl, (C2-C6)alkylsilyl, (C1-C15)alkoxy, (C1-C10)alkoxy, (C1-C8)alkoxy, (C1-C6)alkoxy, (C1-C5)alkoxy, (C1-C4)alkoxy, (C2-C6)alkoxy, (C3-C15) cycloalkyl, (C3-C12) cycloalkyl, (C3-C10) cycloalkyl, (C3-C8) cycloalkyl, (C5-C8) cycloalkyl, (C5-C6) cycloalkyl, (C6-C20)aryl, (C6-C15)aryl, (C6-C12)aryl, (C6-C10)aryl, (C6-C9)aryl, (C6-C10)aryl(C1-C15)alkyl, (C6-C10)aryl(C1-C10)alkyl, (C6-C10)aryl(C1-C8)alkyl, (C6-C10)aryl(C1-C6)alkyl, (C6-C10)aryl(C1-C5)alkyl, (C6-C10)aryl(C1-C4)alkyl, (C6-C10)aryl(C2-C6)alkyl, (C1-C15)alkyl(C6-C10)aryl, (C1-C10)alkyl(C6-C10)aryl, (C1-C8)alkyl(C6-C10)aryl, (C1-C6)alkyl(C6-C10)aryl, (C1-C5)alkyl(C6-C10)aryl, (C1-C4)alkyl(C6-C10)aryl, or (C2-C6)alkyl(C6-C10)aryl; and the alkyl, the alkylsilyl, the alkoxy, the cycloalkyl, the aryl, the arylalkyl, and the alkylaryl of R¹⁵ to R²² may be substituted by any one or more selected from the group consisting of halogen, (C1-C8)alkyl, (C1-C5)alkyl, (C1-C3)alkyl, (C1-C8)alkylamino, (C1-C5)alkylamino, (C1-C3)alkylamino, (C1-C8)alkoxy, (C1-C5)alkoxy, (C1-C3)alkoxy, (C1-C8)alkylsilyl, (C1-C5)alkylsilyl, and (C1-C3)alkylsilyl.

Otherwise, in an embodiment, R¹⁵ to R²² may be connected by (C3-C10)alkylene, (C3-C8)alkylene, (C3-C6)alkylene, (C3-C5)alkylene, (C3-C4)alkylene, (C3-C10)alkenylene, (C3-C8)alkenylene, (C3-C6)alkenylene, (C3-C5)alkenylene, or (C3-C4)alkenylene with or without a fused ring between adjacent substituents to form a monocyclic or polycyclic alicyclic ring or aromatic ring. Otherwise, the formed alicyclic ring or the aromatic ring may be substituted by any one or more selected from the group consisting of (C1-C8)alkyl, (C1-C6)alkyl, (C1-C5)alkyl, (C1-C4)alkyl, (C2-C6)alkyl, (C1-C8)alkoxy, (C1-C6)alkoxy, (C1-C5)alkoxy, (C1-C4)alkoxy, (C2-C6)alkoxy, (C1-C10)alkoxy (C1-C8)alkyl, (C1-C10)alkoxy (C1-C6)alkyl, (C1-C10)alkoxy (C1-C5)alkyl, (C1-C10)alkoxy (C1-C4)alkyl, (C1-C10)alkoxy (C2-C6)alkyl, (C6-C9)aryl, (C6-C8)aryl, (C6-C10)aryl(C1-C8)alkyl, (C6-C10)aryl(C1-C6)alkyl, (C6-C10)aryl(C1-C5)alkyl, (C6-C10)aryl(C1-C4)alkyl, (C6-C10)aryl(C2-C6)alkyl, (C1-C8)alkylsilyl, (C1-C6)alkylsilyl, (C1-C5)alkylsilyl, (C1-C4)alkylsilyl, (C6-C9)arylsilyl, and (C6-C8)arylsilyl.

Specifically, in an embodiment, R¹⁵, R¹⁶, R¹⁸, R¹⁹, R²¹, and R²² may be hydrogen, and R¹⁷ and R²⁰ may be tert-butyl.

In an embodiment, B¹ and B² may be independently of each other (C1-C15)alkyl, (C1-C10)alkyl, (C1-C8)alkyl, (C1-C6)alkyl, (C1-C5)alkyl, (C1-C4)alkyl, (C2-C6)alkyl, (C2-C20)alkenyl, (C2-C15)alkenyl, (C2-C10)alkenyl, (C2-C8)alkenyl, (C2-C6)alkenyl, (C2-C5)alkenyl, (C2-C4)alkenyl, (C1-C15)alkoxy, (C1-C10)alkoxy, (C1-C8)alkoxy, (C1-C6)alkoxy, (C1-C5)alkoxy, (C1-C4)alkoxy, (C2-C6)alkoxy, (C1-C6)alkoxy (C1-C15)alkyl, (C1-C6)alkoxy (C1-C10)alkyl, (C1-C6)alkoxy (C1-C8)alkyl, (C1-C6)alkoxy (C1-C6)alkyl, (C1-C6)alkoxy (C1-C5)alkyl, (C1-C6)alkoxy (C1-C4)alkyl, (C1-C6)alkoxy (C2-C6)alkyl, (C3-C15) cycloalkyl, (C3-C12) cycloalkyl, (C3-C10) cycloalkyl, (C3-C8) cycloalkyl, (C5-C8) cycloalkyl, (C5-C6) cycloalkyl, (C6-C20)aryl, (C6-C15)aryl, (C6-C12)aryl, (C6-C10)aryl, (C6-C9)aryl, (C6-C10)aryl(C1-C15)alkyl, (C6-C10)aryl(C1-C10)alkyl, (C6-C10)aryl(C1-C8)alkyl, (C6-C10)aryl(C1-C6)alkyl, (C6-C10)aryl(C1-C5)alkyl, (C6-C10)aryl(C1-C4)alkyl, (C6-C10)aryl(C2-C6)alkyl, (C1-C15)alkyl(C6-C10)aryl, (C1-C10)alkyl(C6-C10)aryl, (C1-C8)alkyl(C6-C10)aryl, (C1-C6)alkyl(C6-C10)aryl, (C1-C5)alkyl(C6-C10)aryl, (C1-C4)alkyl(C6-C10)aryl, or (C2-C6)alkyl(C6-C10)aryl, (C1-C15)alkylsilyl, (C1-C10)alkylsilyl, (C1-C8)alkylsilyl, (C1-C6)alkylsilyl, (C1-C5)alkylsilyl, (C1-C4)alkylsilyl, (C2-C6)alkylsilyl, (C6-C20)arylsilyl, (C6-C15)arylsilyl, (C6-C12)arylsilyl, (C6-C10)arylsilyl, or (C6-C9)arylsilyl, and specifically, may be phenyl.

In an embodiment, the transition metal compound may be a compound represented by the following Chemical Formula 1B:

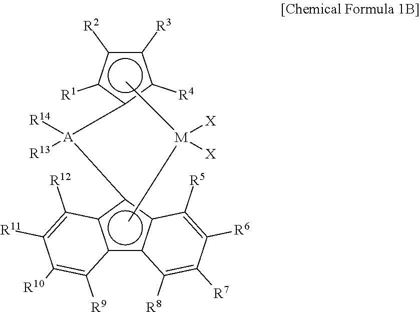

wherein
M is a Group 4 transition metal in the periodic table;
A is carbon or silicon;
R¹ to R⁴ are independently of one another hydrogen or (C1-C20)alkyl;
R⁵ to R¹² are independently of one another hydrogen, (C1-C20)alkyl, (C1-C20)alkoxy, (C3-C20) cycloalkyl, (C6-C20)aryl, (C6-C20)aryl(C1-C20)alkyl, (C1-C20)alkyl(C6-C20)aryl, (C1-C20)alkylsilyl, or (C6-C20)arylsilyl; or R⁵ to R¹² may be connected by (C3-C12)alkylene or (C3-C12)alkenylene with or without a fused ring between adjacent substituents to form an alicyclic ring or aromatic ring; and the alicyclic ring and the aromatic ring may be substituted by any one or more selected from the group consisting of (C1-C10)alkyl, (C1-C10)alkoxy, (C1-C10)alkoxy (C1-C10)alkyl, (C6-C10)aryl, (C6-C10)aryl(C1-C10)alkyl, (C1-C10)alkyl(C6-C10)aryl, (C1-C10)alkylsilyl, and (C6-C10)arylsilyl; and
R¹³ and R¹⁴ are independently of each other (C6-C20)aryl.

In an embodiment, M may be, for example, Ti, Zr, or Hf.

In an embodiment, R¹ to R⁴ may be independently of one another hydrogen, (C1-C15)alkyl, (C1-C10)alkyl, (C1-C8)alkyl, (C1-C6)alkyl, (C1-C5)alkyl, (C1-C4)alkyl, (C1-C3)alkyl, or (C2-C6)alkyl.

In an embodiment, R⁵ to R¹² may be independently of one another hydrogen, (C1-C15)alkyl, (C1-C10)alkyl, (C1-C8)alkyl, (C1-C6)alkyl, (C1-C5)alkyl, (C1-C4)alkyl, (C1-C3)alkyl, (C2-C6)alkyl, (C1-C15)alkoxy, (C1-C10)alkoxy, (C1-C8)alkoxy, (C1-C6)alkoxy, (C1-C5)alkoxy, (C1-C4)alkoxy, (C1-C3)alkoxy, (C2-C6)alkoxy, (C3-C15) cycloalkyl, (C3-C12) cycloalkyl, (C3-C10) cycloalkyl, (C3-C8) cycloalkyl, (C5-C8) cycloalkyl, (C5-C6) cycloalkyl, (C6-C15)aryl, (C6-C12)aryl, (C6-C10)aryl, (C6-C9)aryl, (C6-C10)aryl(C1-C15)alkyl, (C6-C10)aryl(C1-C10)alkyl, (C6-C10)aryl(C1-C8)alkyl, (C6-C10)aryl(C1-C6)alkyl, (C6-C10)aryl(C1-C5)alkyl, (C6-C10)aryl(C1-C4)alkyl, (C6-C10)aryl(C2-C6)alkyl, (C1-C15)alkyl(C6-C10)aryl, (C1-C10)alkyl(C6-C10)aryl, (C1-C8)alkyl(C6-C10)aryl, (C1-C6)alkyl(C6-C10)aryl, (C1-C5)alkyl(C6-C10)aryl, (C1-C4)alkyl(C6-C10)aryl, or (C2-C6)alkyl(C6-C10)aryl, (C1-C15)alkylsilyl, (C1-C10)alkylsilyl, (C1-C8)alkylsilyl, (C1-C6)alkylsilyl, (C1-C5)alkylsilyl, (C1-C4)alkylsilyl, (C2-C6)alkylsilyl, (C6-C20)arylsilyl, (C6-C15)arylsilyl, (C6-C12)arylsilyl, (C6-C10)arylsilyl, or (C6-C9)arylsilyl.

Otherwise, in an embodiment, R⁵ to R¹² may be connected by (C3-C10)alkylene, (C3-C8)alkylene, (C3-C6)alkylene, (C3-C5)alkylene, (C3-C4)alkylene, (C3-C10)alkenylene, (C3-C8)alkenylene, (C3-C6)alkenylene, (C3-C5)alkenylene, or (C3-C4)alkenylene with or without a fused ring between adjacent substituents to form a monocyclic or polycyclic alicyclic ring or aromatic ring. The alicyclic ring and the aromatic ring may be substituted by any one or more selected from the group consisting of (C1-C10)alkyl, (C1-C10)alkoxy, (C1-C10)alkoxy (C1-C10)alkyl, (C6-C10)aryl, (C6-C10)aryl(C1-C10)alkyl, (C1-C10)alkyl(C6-C10)aryl, (C1-C10)alkylsilyl, and (C6-C10)arylsilyl.

In an embodiment, R¹³ and R¹⁴ may be independently of each other (C6-C15)aryl, (C6-C12)aryl, (C6-C10)aryl, (C6-C9)aryl, or phenyl.

In an embodiment, the transition metal compound may be a compound represented by the following Chemical Formula 1C:

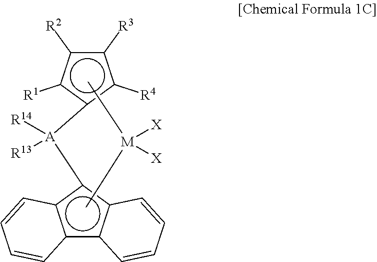

wherein
M is Ti, Zr, or Hf;
A is carbon or silicon;
R¹ to R⁴ are independently of one another hydrogen or (C1-C20)alkyl; and
R¹³ and R¹⁴ are independently of each other (C6-C10)aryl.

In an embodiment, R¹ to R⁴ may be independently of one another (C1-C15)alkyl, (C1-C10)alkyl, (C1-C8)alkyl, (C1-C6)alkyl, (C1-C5)alkyl, (C1-C4)alkyl, (C1-C3)alkyl, or (C2-C6)alkyl.

In an embodiment, R¹³ and R¹⁴ may be independently of each other (C6-C8)aryl or phenyl.

In an embodiment, the compound represented by Chemical Formula 1A, Chemical Formula 1B, or Chemical Formula 1C may be specifically

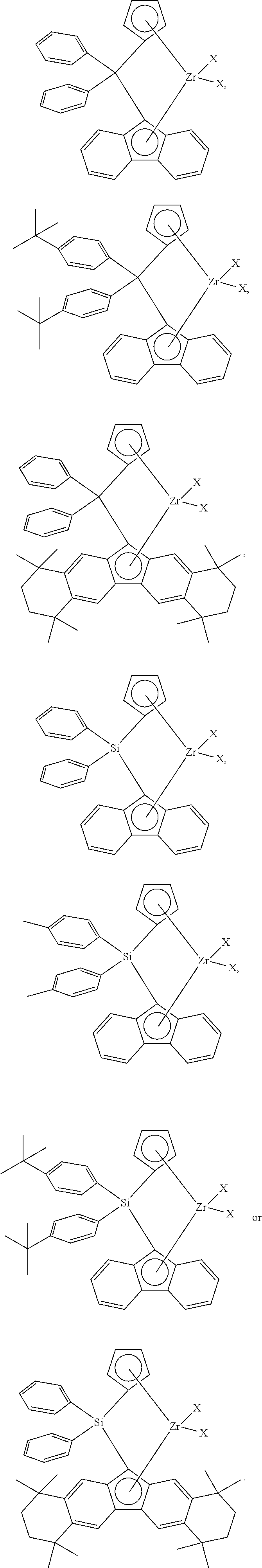

However, the compound is only an example, and the present disclosure is not necessarily limited thereto.

In an embodiment, a compound represented by Chemical Formula 2A is a charac-teristic substituent to implement excellent activity of the transition metal compound according to one implementation, and specifically, for example, may be

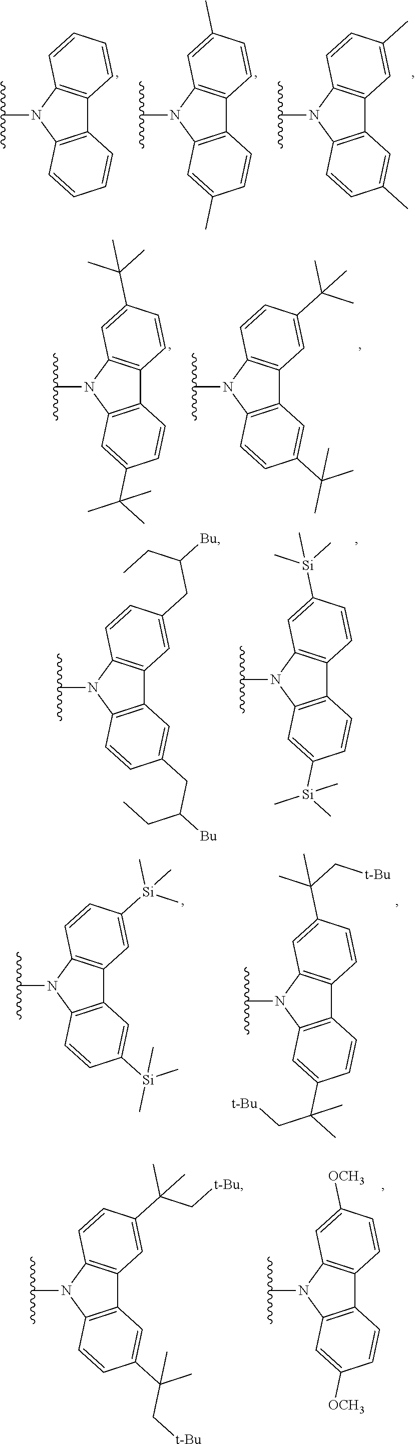

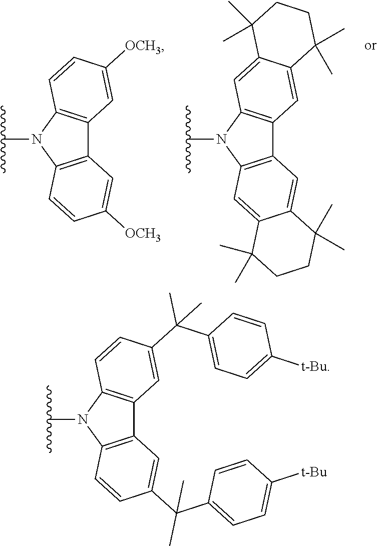

However, the compound is only an example, and the present disclosure is not necessarily limited thereto.

In an embodiment, a specific example of the transition metal compound may comprise

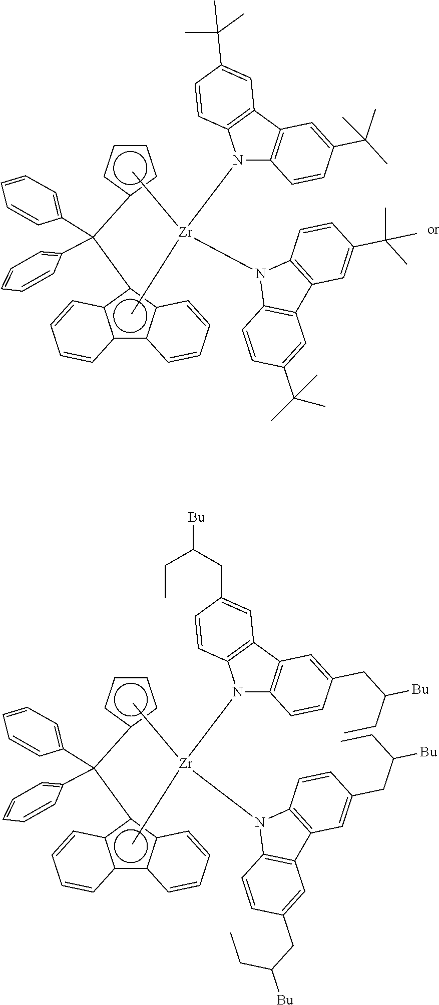

However, since the compound is only an example, it is not necessarily limited thereto, and any compound which is represented by Chemical Formula 1A, 1B, or 1C and comprises a carbazole group represented by Chemical Formula 2A should be regarded as comprising technical means which may implement the effect to be targeted in one implementation or solve the problem to be solved in one implementation.

The transition metal compound according to an embodiment comprises a carbazole substituent to have excellently improved solubility in a solvent, specifically excellently improved solubility in a hydrocarbon-based solvent. In particular, the transition metal compound according to an embodiment has excellent solubility in a non-aromatic hy-drocarbon-based solvent such as methylcyclohexane, cyclohexane, n-heptane, n-hexane, n-butane, isobutane, n-pentane, n-octane, isooctane, nonane, decane, and dodecane as well as an aromatic hydrocarbon-based solvent such as toluene, benzene, ethylbenzene, xylene, naphthalene, methylnaphthalene, anthracene, acenaphthene, and phenanthrene. For example, the transition metal compound according to an embodiment may have a solubility in the hydrocarbon-based solvent at 25° C. of 5 wt % or more, 6 wt % or more, 7 wt % or more, or 7.5 wt % or more. In an embodiment, the hy-drocarbon-based solvent may be a non-aromatic hydrocarbon-based solvent or an aromatic hydrocarbon-based solvent. In particular, the solubility in the non-aromatic hydrocarbon-based solvent may be 20 wt % or more, 30 wt % or more, 35 wt % or more, 40 wt % or more, or 45 wt % or more. Otherwise, the solubility in the non-aromatic hy-drocarbon-based solvent may be 10 wt % or more, 15 wt % or more, 20 wt % or more, 25 wt % or more, or 30 wt % or more. The upper limit of the solubility range may be 100 wt % or less, 80 wt % or less, 70 wt % or less, 60 wt % or less, 50 wt % or less, 48 wt % or less, or 46 wt % or less.

Another implementation provides a transition metal catalyst composition comprising the transition metal compound according to the implementation and a cocatalyst, wherein the transition metal catalyst composition may be for preparing an olefin polymer.

Since the description of the transition metal compound according to the embodiment described above may be applied to the transition metal compound, hereinafter, the description will be omitted.

In an embodiment, the cocatalyst may comprise one or more selected from aluminum compounds, boron compounds, and mixtures thereof.

In an embodiment, the boron compound may be selected from compounds represented by the following Chemical Formula 3A to 3D:

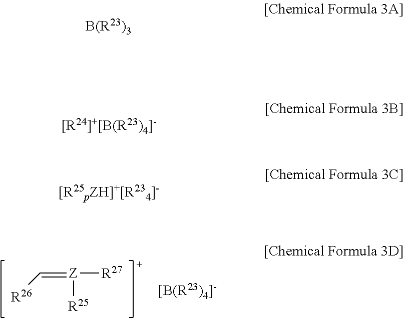

wherein
B is boron;
R²³ is independently of each other phenyl which is unsubstituted or substituted by one or more substituents selected from the group consisting of fluorine, (C1-C20)alkyl, fluorine-substituted (C1-C20)alkyl, (C1-C20)alkoxy, and fluorine-substituted (C1-C20)alkoxy;
R²⁴ is a (C5-C7) aromatic radical, a (C1-C20)alkyl(C6-C20)aryl radical, or (C6-C20)aryl(C1-C20)alkyl radical;
Z is nitrogen or phosphorus;
R²⁵ is independently of each other a (C1-20)alkyl radical or an anilinium radical disubstituted by (C1-C10)alkyl;
R²⁶ is (C5-C20)alkyl;
R²⁷ is (C5-C20)aryl or (C1-20)alkyl(C5-C20)aryl; and
P is 2 or 3.

In an embodiment, R²³ may be independently of each other phenyl which is unsubstituted or substituted by one or more substituents selected from the group consisting of fluorine; (C1-C15)alkyl, (C1-C10)alkyl, (C1-C8)alkyl, (C1-C6)alkyl, (C1-C5)alkyl, (C1-C4)alkyl, (C1-C3)alkyl, or (C2-C6)alkyl which is unsubstituted or substituted by fluorine; and (C1-C15)alkoxy, (C1-C10)alkoxy, (C1-C8)alkoxy, (C1-C6)alkoxy, (C1-C5)alkoxy, (C1-C4)alkoxy, (C1-C3)alkoxy, or (C2-C6)alkoxy which is unsubstituted or substituted by fluorine.

In an embodiment, R²⁴ may be a (C5-C6) aromatic radical, a (C1-C10)alkyl(C6-C20)aryl radical, a (C1-C10)alkyl(C6-C15)aryl radical, a (C1-C10)alkyl(C6-C12)aryl radical, a (C1-C10)alkyl(C6-C10)aryl radical, a (C1-C10)alkyl(C6-C9)aryl radical, a (C6-C10)aryl(C1-C15)alkyl radical, a (C6-C10)aryl(C1-C10)alkyl radical, a (C6-C10)aryl(C1-C8)alkyl radical, a (C6-C10)aryl(C1-C6)alkyl radical, a (C6-C10)aryl(C1-C5)alkyl radical, a (C6-C10)aryl(C1-C4)alkyl radical, a (C6-C10)aryl(C1-C3)alkyl radical, or a (C6-C10)aryl(C2-C6)alkyl radical.

In an embodiment, R²⁵ may be independently of each other a (C1-C15)alkyl radical, a (C1-C10)alkyl radical, a (C1-C8)alkyl radical, a (C1-C6)alkyl radical, a (C1-C5)alkyl radical, a (C1-C4)alkyl radical, a (C1-C3)alkyl radical, or a (C2-C6)alkyl radical; or an anilinium radical disubstituted by (C1-C10)alkyl, (C1-C8)alkyl, (C1-C6)alkyl, (C1-C5)alkyl, (C1-C4)alkyl, (C1-C3)alkyl, or (C2-C6)alkyl. The alkyl substituents which are disubstituted on the anilinium radical may be substituted on a nitrogen atom of anilinium.

In an embodiment, R²⁶ may be (C5-C15)alkyl, (C5-C10)alkyl, (C5-C8)alkyl, or (C5-C6)alkyl.

In an embodiment, R²⁷ may be (C5-C15)aryl, (C5-C10)aryl, (C5-C8)aryl, (C5-C6)aryl, (C1-10)alkyl(C5-C20)aryl, (C1-10)alkyl(C5-C15)aryl, (C1-10)alkyl(C5-C10)aryl, (C1-10)alkyl(C5-C8)aryl, or (C1-10)alkyl(C5-C6)aryl.

In an embodiment, the boron compound may be, for example, trityl tetrakispentafluorophenylborate, trispentafluorophenylborane, tris 2,3,5,6-tetrafluorophenylborane, tris 2,3,4,5-tetrafluorophenylborane, tris 3,4,5-trifluorophenylborane, tris 2,3,4-trifluorophenylborane, phenylbispentafluorophenylborane, tetrakispentafluorophenylborate, tetrakis 2,3,5,6-tetrafluorophenylborate, tetrakis 2,3,4,5-tetrafluorophenylborate, tetrakis 3,4,5-trifluorophenylborate, tetrakis 2,2,4-trifluorophenylborate, phenylbispentafluorophenylborate, or tetrakis 3,5-bistrifluoromethylphenylborate. In addition, a specific combination example thereof comprises ferrocenium tetrakispentafluorophenylborate, 1,1′-dimethylferrocenium tetrakispentafluorophenylborate, silver tetrakispentafluorophenylborate, triphenylmethyl tetrakispentafluorophenylborate, triphenylmethyl tetrakis 3,5-bistrifluoromethylphenylborate, triethylammonium tetrakispentafluorophenylborate, tripropylammonium tetrakispentafluorophenylborate, trinormal butylammonium tetrakispentafluorophenylborate, trinormal butylammonium tetrakis 3,5-bistrifluoromethylphenylborate, N,N-dimethylanilinium tetrakispentafluorophenylborate, N,N-diethylanilinium tetrakispentafluorophenylborate, N,N-2,4,6-pentamethylanilinium tetrakispentafluorophenylborate, N,N-dimethylanilinium tetrakis 3,5-bistrifluoromethylphenylborate, diisopropy-lammonium tetrakispentafluorophenylborate, dicyclohexylammonium tetrakispentafluorophenylborate, triphenylphosphonium tetrakispentafluorophenylborate, trimethylphenylphosphonium tetrakispentafluorophenylborate, or tridimethylphenylphosphonium tetrakispentafluorophenylborate.

In an embodiment, the aluminum compound may be selected from an aluminoxane compound represented by the following Chemical Formula 4A or 4B, an organoaluminum compound represented by the following Chemical Formula 4C, or an organoaluminum alkyloxide or organoaluminum aryloxide compound represented by Chemical Formula 4D or 4E:

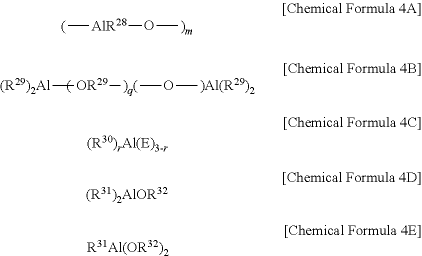

wherein
R²⁸ and R²⁹ are independently of each other (C1-C20)alkyl;
m and q are independently of each other an integer of 5 to 20;
R³⁰ and R³¹ are independently of each other (C1-C20)alkyl;
E is hydrogen or halogen;
r is an integer of 1 to 3; and
R³² is (C1-C20)alkyl or (C6-C30)aryl.

In an embodiment, R²⁸ and R²⁹ may be independently of each other (C1-C15)alkyl, (C1-C10)alkyl, (C1-C8)alkyl, (C1-C6)alkyl, (C1-C5)alkyl, (C1-C4)alkyl, (C1-C3)alkyl, or (C2-C6)alkyl.

In an embodiment, m and q may be independently of each other an integer of 5 to 15, 5 to 10, or 5 to 8.

In an embodiment, R³⁰ and R³¹ may be independently of each other (C1-C15)alkyl, (C1-C10)alkyl, (C1-C8)alkyl, (C1-C6)alkyl, (C1-C5)alkyl, (C1-C4)alkyl, (C1-C3)alkyl, or (C2-C6)alkyl.

In an embodiment, r may be 1, 2, or 3.

In an embodiment, R³² may be (C1-C15)alkyl, (C1-C10)alkyl, (C1-C8)alkyl, (C1-C6)alkyl, (C1-C5)alkyl, (C1-C4)alkyl, (C1-C3)alkyl, (C2-C6)alkyl, (C6-C25)aryl, (C6-C20)aryl, (C6-15)aryl, (C6-C10)aryl, (C6-C9)aryl, or (C6-C8)aryl.

In an embodiment, the aluminum compound may be, for example, methylaluminoxane, modified methylaluminoxane, tetraisobutylaluminoxane, and the like; an example of the organoaluminum compound may comprise: trialkylaluminum comprising trimethylaluminum, triethylaluminum, tripropylaluminum, triisobuty-laluminum, and trihexylaluminum; dialkylaluminumchloride comprising dimethylalu-minumchloride, diethylaluminumchloride, dipropylaluminum chloride, diisobutylalu-minumchloride, and dihexylaluminumchloride; alkylaluminumdichloride comprising methylaluminumdichloride, ethylaluminumdichloride, propylaluminumdichloride, isobutylaluminumdichloride, and hexylaluminumdichloride; dialkylaluminumhydride comprising dimethylaluminumhydride, diethylaluminumhydride, dipropylalu-minumhydride, diisobutylaluminumhydride, and dihexylaluminumhydride; and alky-lalkoxyaluminum comprising methyldimethoxyaluminum, dimethyl-methoxyaluminum, ethyldiethoxyaluminum, diethylethoxyaluminum, isobutyldibu-toxyaluminum, diisobutylbutoxyaluminum, hexyldimethoxyaluminum, dihexyl-methoxyaluminum, and dioctylmethoxyaluminum.

In an embodiment, the olefin polymer may be an ethylene homopolymer or a copolymer of ethylene and α-olefin.

Another implementation provides a method for preparing an olefin polymer comprising: subjecting an olefin monomer to solution polymerization under the transition metal compound according to the implementation, a cocatalyst, and a hy-drocarbon-based solvent to obtain an olefin polymer.

Since the above descriptions may be applied to the transition metal compound, the cocatalyst, and the olefin polymer, hereinafter, the descriptions thereof will be omitted.

In an embodiment, the hydrocarbon-based solvent may be a C3-C20 non-aromatic hydrocarbon-based solvent, and for example, may be one or more non-aromatic hy-drocarbon-based solvents selected from the group consisting of methylcyclohexane, cyclohexane, n-heptane, n-hexane, n-butane, isobutane, n-pentane, n-octane, isooctane, nonane, decane, and dodecane. Otherwise, the hydrocarbon-based solvent may be a C3-C20 aromatic hydrocarbon-based solvent, and for example, may comprise one or more aromatic hydrocarbon-based solvents selected from the group consisting of toluene, benzene, ethylbenzene, xylene, naphthalene, methylnaphthalene, anthracene, acenaphthene, and phenanthrene.

The transition metal compound according to an embodiment comprises a carbazole substituent to have excellently improved solubility in a solvent, specifically excellently improved solubility in a hydrocarbon-based solvent. In particular, the transition metal compound according to an embodiment has excellent solubility in a non-aromatic hy-drocarbon-based solvent such as methylcyclohexane, cyclohexane, n-heptane, n-hexane, n-butane, isobutane, n-pentane, n-octane, isooctane, nonane, decane, and dodecane as well as an aromatic hydrocarbon-based solvent such as toluene, benzene, ethylbenzene, xylene, naphthalene, methylnaphthalene, anthracene, acenaphthene, and phenanthrene. For example, the transition metal compound according to an embodiment may have a solubility in the hydrocarbon-based solvent at 25° C. of 5 wt % or more, 6 wt % or more, 7 wt % or more, or 7.5 wt % or more. In an embodiment, the hy-drocarbon-based solvent may be a non-aromatic hydrocarbon-based solvent or an aromatic hydrocarbon-based solvent. In particular, the solubility in the non-aromatic hydrocarbon-based solvent may be 20 wt % or more, 30 wt % or more, 35 wt % or more, 40 wt % or more, or 45 wt % or more. Otherwise, the solubility in a non-aromatic hy-drocarbon-based solvent may be 10 wt % or more, 15 wt % or more, 20 wt % or more, 25 wt % or more, or 30 wt % or more. The upper limit of the solubility range may be 100 wt % or less, 80 wt % or less, 70 wt % or less, 60 wt % or less, 50 wt % or less, 48 wt % or less, or 46 wt % or less.

In an embodiment, the solution polymerization may be performed at 100° C. to 200° C., 100° C. to 180° C., 100° C. to 150° C., 100° C. to 140° C., 110° C. to 130° C., or about 120° C.

In the method for preparing an olefin polymer according to an embodiment, a mole ratio between the transition metal compound and the cocatalyst may be 1:0.05 to 1:10,000.

In the method for preparing an olefin polymer according to an embodiment, a mole ratio between a transition metal of the transition metal compound and a boron atom comprised in the cocatalyst may be 1:0.01 to 1:100 or 1:0.05 to 1:5. Otherwise, a mole ratio between the transition metal of the transition metal compound and an aluminum atom comprised in the cocatalyst may be 1:10 to 1:1,000 or 1:25 to 1:500.

The method for preparing an olefin polymer according to an embodiment may be performed by contacting the transition metal compound, the cocatalyst, and ethylene, or, if necessary, a vinyl-based comonomer in the presence of a hydrocarbon-based solvent. Herein, the transition metal compound and the cocatalyst component may be added to a reactor by separately adding the reactor or previously mixing each component, and mixing conditions such as an addition order, temperature or concentration are not separately limited.

In an embodiment, when a copolymer of ethylene and α-olefin is prepared, (C3-C18) α-olefin may be used as a comonomer with ethylene, and for example, may be one or two or more selected from propylene, 1-butene, 1-pentene, 4-methyl-1-pentene, 1-hexene, 1-octene, 1-decene, 1-dodecene, 1-hexadecene, and 1-octadecene. More specifically, 1-butene, 1-hexene, 1-octene or 1-decene and ethylene may be copolymerized.

In an embodiment, pressure of ethylene may be 1 atm to 1,000 atm or 10 atm or 150 atm.

A copolymer prepared by the preparation method according to an embodiment may comprise 30 wt % to 99 wt %, 30 wt % to 80 wt %, 50 wt % to 99 wt %, or 60 wt % to 99 wt % of a unit derived from ethylene, based on the total weight.

In the method for preparing an olefin polymer according to an embodiment, a linear low-density polyethylene LLDPE which is prepared using (C4-C10) α-olefin as a comonomer has a density area of 0.940 g/cc or less, and may be extended to a very low density polyethylene (VLDPE), a ultra-low density polyethylene (ULDPE), or even an olefin elastomer. In addition, in the preparation of an ethylene copolymer in an embodiment, hydrogen may be used as a molecular weight adjusting agent for adjusting a molecular weight may be used, and the prepared copolymer may have a weight average molecular weight o (Mw) of 80,000 g/mol to 500,000 g/mol.

As a specific example of an olefin-diene copolymer prepared by the catalyst composition according to an embodiment, an ethylene-propylene-diene copolymer containing 30 wt % to 80 wt % of ethylene (or unit derived from ethylene), 20 wt % to 70 wt % of propylene (or unit derived from propylene), and 0 to 15 wt % of diene (or unit derived from diene) may be prepared. A diene monomer which may be used in an embodiment has two or more double bonds and may be one or two or more selected from 1,4-hexadiene, 1,5-hexadiene, 1,5-heptadiene, 1,6-heptadiene, 1,6-octadiene, 1,7-octadiene, 1,7-nonadiene, 1,8-nonadiene, 1,8-decadiene, 1,9-decadiene, 1,12-tetradecadiene, 1,13-tetradecadiene, 3-methyl-1,4-hexadiene, 3-methyl-1,5-hexadiene, 3-ethyl-1,4-hexadiene, 3-ethyl-1,5-hexadiene, 3,3-dimethyl-1,4-hexadiene, 3,3-dimethyl-1,5-hexadiene, 5-vinyl-2-norbornene, 2,5-norbornadiene, 7-methyl-2,5-norbornadiene, 7-ethyl-2,5-norbornadiene, 7-propyl-2,5-norbornadiene, 7-butyl-2,5-norbornadiene, 7-phenyl-2,5-norbornadiene, 7-hexyl-2,5-norbornadiene, 7,7-dimethyl-2,5-norbornadiene, 7-methyl-7-ethyl-2,5-norbornadiene, 7-chloro-2,5-norbornadiene, 7-bromo-2,5-norbornadiene, 7-fluoro-2,5-norbornadiene, 7,7-dichloro-2,5-norbornadiene, 1-methyl-2,5-norbornadiene, 1-ethyl-2,5-norbornadiene, 1-propyl-2,5-norbornadiene, 1-butyl-2,5-norbornadiene, 1-chloro-2,5-norbornadiene, 1-bromo-2,5-norbornadiene, 5-isopropyl-2-norbornene, 1,4-cyclohexadiene, bicyclo2,2,1 hepta-2,5-diene, 5-ethylidene-2-norbornene, 5-methylene-2-norbornene, bicyclo2,2,2octa-2,5-diene, 4-vinylcyclohexa-1-ene, bicyclo2,2,2octa-2,6-diene, 1,7,7-trimethyl bicyclo-2,2,1hepta-2,5-dicne, dicy-clopentadiene, phenyltetrahydroindene, 5-arylbicyclo2,2,1hepta-2-ene, 1,5-cyclooctadiene, 1,4-diarylbenzene, butadiene, isoprene, 2,3-dimethyl-1,3-butadiene, 1,3-butadiene, 4-methyl-1,3-pentadiene, 1,3-pentadiene, 3-methyl-1,3-pentadiene, 2,4-dimethyl-1,3-pentadiene, and 3-ethyl-1,3-pentadiene. The diene monomer may be selected depending on the processing properties of the ethylene-propylene-diene copolymer.

In the case of generally preparing an ethylene-propylene-diene copolymer, when the content of propylene is increased, the molecular weight of the copolymer is decreased, but in the case of preparing the ethylene-propylene-diene copolymer according to an embodiment, a product having a relatively high molecular weight may be prepared without a decrease in the molecular weight, even with the content of propylene increased to 50 wt %.

Since the catalyst composition presented in the present specification is in a uniform form in a polymerization reactor, it may be more appropriate to apply the catalyst composition to a solution polymerization process which is carried out at a temperature equal to or higher than a melting point of the polymer. However, as disclosed in U.S. Pat. No. 4,752,597, the catalyst composition may be used in a slurry polymerization or gas phase polymerization process in the form of a heterogeneous catalyst composition which is obtained by supporting the transition metal compound and the cocatalyst on a porous metal oxide support.

### MODE FOR THE INVENTION

Hereinafter, the novel transition metal compound according to one implementation, the catalyst composition comprising the same, and the method for preparing an olefin polymer using the same will be described with detailed illustration by the examples and the experimental examples. However, since the examples and the experimental examples described later only illustrate a part of one embodiment, the technology described in the present specification should not be construed as being limited thereto.

Unless otherwise stated, all synthesis experiments of transition metal compounds were carried out using a standard Schlenk or glove box technology under a nitrogen atmosphere, and as an organic solvent used in the reaction, an organic solvent obtained by refluxing under sodium metal and benzophenone to remove moisture and distilling immediately before use was used. The 1H NMR analysis of the synthesized transition metal compound was carried out using Bruker 400 or 500 MHz at room temperature.

Normal heptane as a polymerization solvent was used, for example, after passing the normal heptane through a 5 Å molecular sieve and a tube filled with active alumina, and bubbling with high purity nitrogen to sufficiently remove moisture, oxygen and other catalyst poisoning materials therefrom. The polymerized polymer was analyzed by the methods described below:
1. Melt flow index (melt index, MI)
measured at 190° C. under a load of 2.16 kg using the analysis method of ASTM D1238.
2. Density
measured by the analysis method of ASTM D792.
3. Molecular weight and molecular weight distribution
measured by gel chromatography having a three-stage mixed column.

The solvent used herein was 1,2,4-trichlorobenzene, and the measurement temperature was 120° C.

### <Example 1> Synthesis of Compound 1

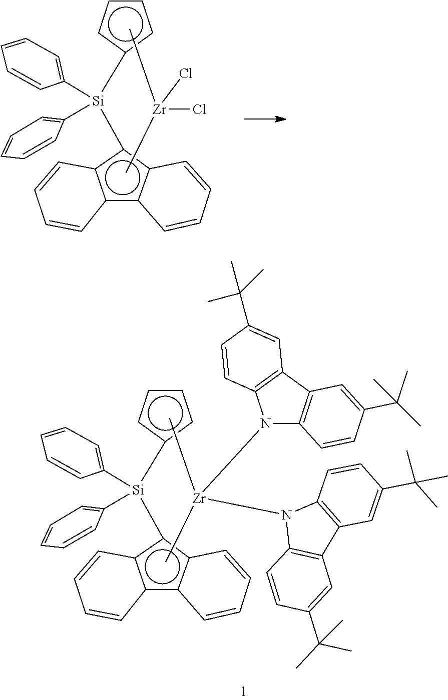

Diphenylmethylidene (cyclopentadienyl) (9-fluorenyl) zirconium dichloride (S—PCI, 5.0 g, 8.9 mmol) and 3,6-di-tert-butylcarbazole (5.0 g, 18.0 mmol) were dissolved in 150 mL of toluene in a 500 mL round flask under a nitrogen atmosphere. 1.6 M butyllithium (11.8 mL, 18.9 mmol) was slowly injected thereto at room temperature, the temperature was raised to 80° C., and stirring was performed for 12 hours. The solvent was removed under vacuum, the concentrated solution was dissolved in 100 mL of methylcyclohexane, and filtration was performed through a filter filled with dried celite to remove a solid content. Remaining solvent was all removed to obtain red Compound 1 of Example 1 (8.30 g, yield: 89.0%).

¹H NMR (500 MHz, Chloroform-d): 0=8.38 (d, 2H), 8.01 (dd, 4H), 7.68 (m, 2H), 7.57 (m, 2H), 7.31 (m, 4H), 7.15 (d, 2H), 7.03 (t, 2H), 6.63 (m, 2H), 6.58 (d, 2H), 6.52 (d, 2H), 6.58 (d, 2H), 6.44 (m, 2H), 6.41 (d, 2H), 6.31 (m, 4H), 6.05 (m, 4H), 1.41 (s, 18H), 1.39 (s, 18H).

### <Example 2> Synthesis of Compound 2

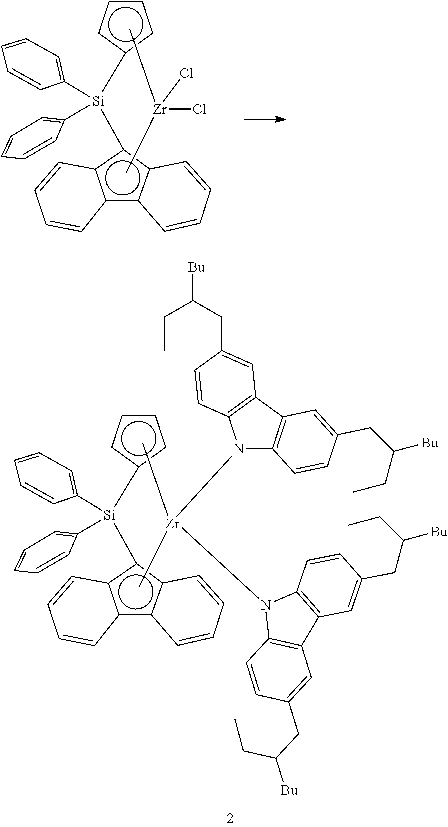

9-Fluorenyl 1-diphenylsilylcyclopentadienylzirconium dichloride (TFC, 5.0 g, 8.7 mmol) and 3,6-bis(2-ethylhexyl)-9H-carbazole (6.8 g, 17.5 mmol) were dissolved in 150 mL of toluene in a 500 mL round flask under a nitrogen atmosphere. 1.6 M butyllithium (10.9 mL, 17.5 mmol) was slowly injected thereto at room temperature, the temperature was raised to 80° C., and stirring was performed for 12 hours. The solvent was removed under vacuum, the concentrated solution was dissolved in 100 mL of methylcyclohexane, and filtration was performed through a filter filled with dried celite to remove a solid content. Remaining solvent was all removed to obtain red Compound 2 of Example 2 (10.4 g, yield: 92.5%).

¹H NMR (500 MHz, Chloroform-d): 8=8.15 (d, 2H), 7.87 (m, 4H), 7.52 (m, 10H), 7.18 (m, 6H), 6.65 (m, 10H), 6.15 (m, 2H), 2.58 (m, 8H), 1.67 (m, 4H), 1.29 (m, 44H), 0.88 (m, 12H).

### Comparative Example 1

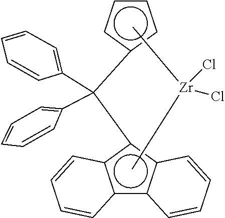

The compound diphenylmethylidene (cyclopentadienyl) (9-fluorenyl) zirconium dichloride was prepared through purchase from S—PCI.

### Comparative Example 2

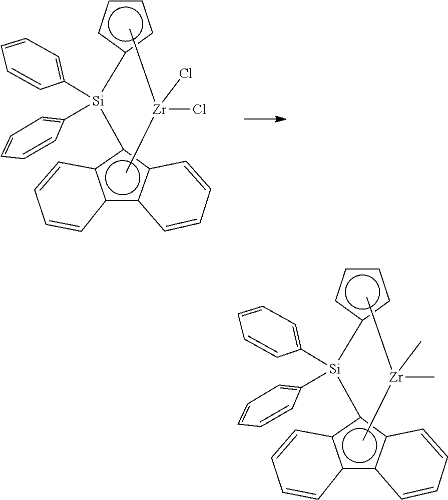

Diphenylmethylidene (cyclopentadienyl) (9-fluorenyl) zirconium dichloride (S—PCI, 10.0 g, 18.0 mmol) was dissolved in 100 mL of toluene in a 250 mL round flask under a nitrogen atmosphere. The temperature was lowered to −15° C., 1.5 M methyllithium (24.0 mL, 35.9 mmol) was slowly injected thereto, the temperature was raised to room temperature, stirring was performed for 3 hours, and filtration was performed with a filter filled with dried celite to remove a solid content. After filtration, remaining solvent was all removed to obtain a red compound of Comparative Example 2 (8.5 g, yield: 91.4%).

¹H NMR (500 MHz, Chloroform-d): 8=8.20 (d, 2H), 7.85 (dd, 4H), 7.41 (m, 4H), 7.28 (m, 4H), 6.89 (m, 2H), 6.28 (m, 4H), 5.54 (m, 2H), -1.69 (s, 6H).

### Comparative Example 3

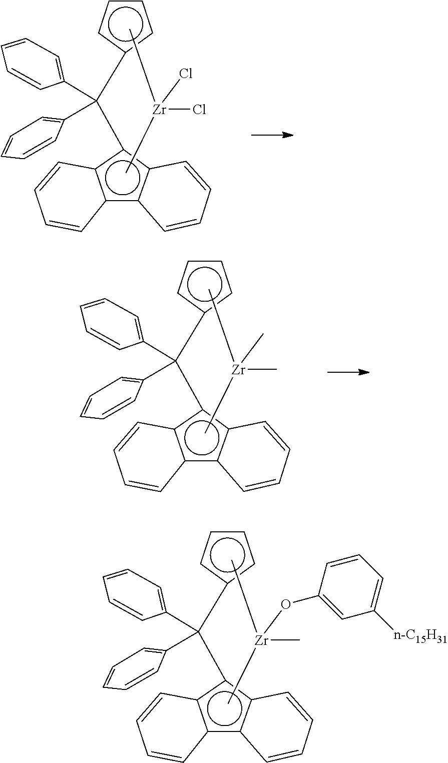

Diphenylmethylidene (cyclopentadienyl) (9-fluorenyl) zirconium dichloride (S—PCI, 10.0 g, 18.0 mmol) was dissolved in 100 mL of toluene in a 250 mL round flask under a nitrogen atmosphere. The temperature was lowered to −15° C., 1.5 M methyllithium (24.0 mL, 35.9 mmol) was slowly injected thereto, the temperature was raised to room temperature, and stirring was performed for 3 hours. 3-pentadecylphenol (5.48 g, 18.0 mmol) was added while the reaction mixture was strongly stirred, stirring was performed at 60° C. for 3 hours, and then the solvent was removed under vacuum. The concentrated solution was dissolved in 200 mL of normal hexane and filtered through a filter filled with dried celite to remove a solid content. Remaining solvent was all removed to obtain a yellow compound of Comparative Example 3 (18.7 g, yield: 95.4%)

¹H NMR (CDCl₃, 500 MHz): δ=8.16 (d, 1H), 8.10 (d, 1H), 7.95 (d, 1H), 7.88 (d, 2H), 7.78 (d, 1H), 7.39 (m, 2H), 7.30 (m, 2H), 7.25 (m, 3H), 7.08 (m, 2H), 6.92 (t, 1H), 6.78 (t, 1H), 6.65 (d, 1H), 6.41 (d, 1H), 6.29 (d, 1H), 6.24 (d, 1H), 6.05 (d, 1H), 5.79 (m, 2H), 5.60 (dd, 2H), 2.65 (t, 2H), 1.63 (m, 2H), 1.30 (m, 24H), 0.88 (m, 3H), -1.35 (s, 3H).

### <Experimental Example 1> Measurement of Solubility

In order to compare solubilities of the transition metal compounds prepared in the examples and the comparative examples in solvents, the following experiment was performed. Specifically, 2 g of the transition metal compounds prepared in the examples and the comparative examples under a nitrogen atmosphere were dissolved in 2 g of each solvent (toluene, methylcyclohexane, n-hexane) listed in the following table to prepare a saturated solution, and a solid was removed with a filter of 0.45 μm. Next, the solvent was all removed to weigh the remaining transition metal compound, and the solubility of the transition metal compound was calculated therefrom and is shown in the following Table 1. When the transition metal compound was not dissolved (insoluble) in the solvent, it was indicated as “—”.

TABLE 1

| | Solubility (wt %) | | |
|---|---|---|---|
| | Toluene | Methylcyclohexane | n-hexane |
| Example 1 | 45.6 | 30.2 | 7.8 |
| Example 2 | 53.4 | 35.7 | 12.4 |
| Comparative Example 1 | 0.3 | — | — |
| Comparative Example 2 | 1.1 | — | — |
| Comparative Example 3 | 25.3 | 15.1 | 6.8 |

As shown in Table 1, it is shown that the transition metal compounds prepared in the examples had much higher solubility in a hydrocarbon solvent than the transition metal compounds of Comparative Examples 1 to 3, and in particular, showed surprisingly improved solubility in a non-aromatic hydrocarbon solvent.

### <Examples 3 and 4> Copolymerization of Ethylene and 1—Octene by Continuous Solution Polymerization Process

Copolymerization of ethylene and 1-octene was carried out using a continuous polymerization apparatus, as follows. Each of the catalysts synthesized in Examples 1 and 2 was used as a single active site catalyst, heptane was used as a solvent, and the amount of the catalyst used and other reaction conditions are as shown in the following Table 2. In the following Table 2, Zr is the moles of the catalyst, Al is the moles of modified methylaluminoxane (20 wt %, Nouryon heptane solution), respectively. The catalyst was injected after dissolving it in toluene at a concentration of 0.1 g/L.

As a polymerization result, the conversion rate of the reactor, and the melt flow index and density of the polymer are shown in the following Table 3. The conversion rate was calculated by the reaction conditions and the temperature gradient in the reactor, and the molecular weight was controlled by the reactor temperature and the function of 1-octene content.

### Comparative Example 4

Copolymerization was carried out in the same manner as in Examples 3 and 4, except that the transition metal compound of Comparative Example 3 was used as a catalyst.

TABLE 2

| | | | Comparative |
|---|---|---|---|
| | | | Example 4 |
| | Example 3 | Example 4 | Comparative |
| Transition metal compound | Example 1 | Example 2 | Example 3 |
| Total solution flow rate (kg/h) | 5 | 5 | 5 |
| Amount of ethylene added (wt %) | 8 | 8 | 8 |
| Addition mole ratio of | 2.3 | 2.3 | 2.3 |
| 1-octene (C8) and | | | |
| ethylene (C2) (C8/C2) | | | |
| Zr (μmol/kg) | 4.0 | 4.8 | 6.0 |
| Al/Zr mole ratio | 200 | 200 | 200 |
| Reaction temperature (° C.) | 120 | 120 | 120 |

(In Table 2, “amount of ethylene added” is wt % to “total solution flow rate”.)

TABLE 3

| | | | Comparative |
|---|---|---|---|
| | | | Example 4 |
| | Example 3 | Example 4 | Comparative |
| Transition metal compound | Example 1 | Example 2 | Example 3 |
| C2 conversion rate (%) | 85 | 85 | 85 |
| Melt flow index (MI) | 4.55 | 1.23 | 5.90 |
| Density (g/mL) | 0.8733 | 0.8852 | 0.8739 |
| Weight average molecular | 73,000 | 130,000 | 69,800 |
| weight (g/mol) | | | |

As shown in Table 3, when copolymerization was performed using the transition metal compounds according to the examples as a catalyst, a polymer which had lower MI than the polymer using the transition metal compounds according to the comparative examples as a catalyst, thereby having excellent physical properties and high molecular weight was able to be easily prepared. Therefore, the transition metal compound according to an embodiment significantly increases solubility in a non-aromatic hydrocarbon solvent by introducing a carbazole substituent to a specific position, and thus, allows easy preparation of an olefin polymer by a solution process while maintaining and improving the activity of a catalyst to allow preparation of a polymer having excellent physical properties. Therefore, the use of the compound may bring about an economic saving effect in an industrial process. Hereinabove, though one implementation has been described in detail by the examples and the experimental examples, the scope of one implementation is not limited to the specific examples, and should be construed by the appended claims.

1. A transition metal compound represented by the following Chemical Formula 1A: 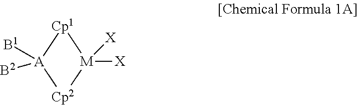
wherein
M is a Group 4 transition metal in the periodic table;
A is carbon or silicon;
Cp¹ and Cp² are independently of each other cyclopentadienyl, indenyl, or fluorenyl; and the cyclopentadienyl, the indenyl, and the fluorenyl may be substituted by any one or more selected from the group consisting of (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, and (C6-C20)arylsilyl;
B¹ and B² are independently of each other (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, or (C6-C20)arylsilyl; and
X is independently of each other represented by the following Chemical Formula 2A: 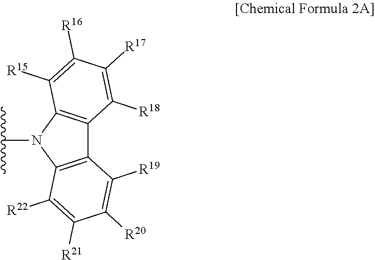
wherein
R¹⁵ to R²² are independently of one another hydrogen, (C1-C30)alkyl, (C1-C30)alkylsilyl, (C1-C30)alkoxy, (C3-C30) cycloalkyl, (C6-C30)aryl, (C6-C30)aryl(C1-C30)alkyl, or (C1-C30)alkyl(C6-C30)aryl; the alkyl, the alkylsilyl, the alkoxy, the cycloalkyl, the aryl, the arylalkyl, and the alkylaryl of R¹⁵ to R²² may be substituted by any one or more selected from the group consisting of halogen, (C1-10)alkyl, (C1-10)alkylamino, (C1-C10)alkoxy, and (C1-C10)alkylsilyl; or R¹⁵ to R²² may be connected by (C3-C12)alkylene or (C3-C12)alkenylene with or without a fused ring between adjacent substituents to form an alicyclic ring or an aromatic ring; and the alicyclic ring and the aromatic ring may be substituted by any one or more selected from the group consisting of (C1-C20)alkyl, (C1-C20)alkoxy, (C1-C20)alkoxy (C1-C20)alkyl, (C6-C20)aryl, (C6-C20)aryl(C1-C20)alkyl, (C1-C20)alkyl(C6-C20)aryl, (C1-C20)alkylsilyl, and (C6-C20)arylsilyl.

2. The transition metal compound of claim 1, wherein R¹⁵ to R²² are independently of one another hydrogen, (C1-C20)alkyl, (C1-C20)alkylsilyl, (C1-C20)alkoxy, (C3-C20) cycloalkyl, (C6-C20)aryl, (C6-C20)aryl(C1-C20)alkyl, or (C1-C20)alkyl(C6-C20)aryl; the alkyl, the alkylsilyl, the alkoxy, the cycloalkyl, the aryl, the arylalkyl, and the alkylaryl of R¹⁵ to R²² may be substituted by any one or more selected from the group consisting of halogen, (C1-10)alkyl, (C1-10)alkylamino, (C1-C10)alkoxy, and (C1-C10)alkylsilyl; or R¹⁵ to R²² may be connected by (C3-C12)alkylene or (C3-C12)alkenylene with or without a fused ring between adjacent substituents to form a alicyclic ring or aromatic ring; and the alicyclic ring and the aromatic ring may be substituted by any one or more selected from the group consisting of (C1-C10)alkyl, (C1-C10)alkoxy, (C1-C10)alkoxy (C1-C10)alkyl, (C6-C10)aryl, (C6-C10)aryl(C1-C10)alkyl, (C1-C10)alkyl(C6-C10)aryl, (C1-C10)alkylsilyl, and (C6-C10)arylsilyl.

3. The transition metal compound of claim 1, wherein the transition metal compound is represented by the following Chemical Formula 1B: 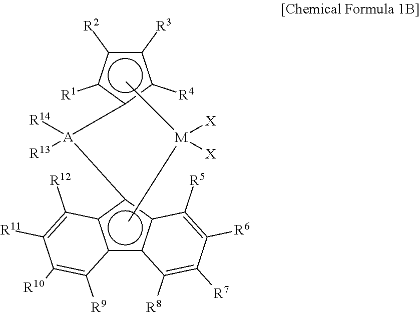
wherein
M is a Group 4 transition metal in the periodic table;
A is carbon or silicon;
R¹ to R⁴ are independently of one another hydrogen or (C1-C20)alkyl;
R⁵ to R¹² are independently of one another hydrogen, (C1-C20)alkyl, (C1-C20)alkoxy, (C3-C20) cycloalkyl, (C6-C20)aryl, (C6-C20)aryl(C1-C20)alkyl, (C1-C20)alkyl(C6-C20)aryl, (C1-C20)alkylsilyl, or (C6-C20)arylsilyl; or R⁵ to R¹² may be connected by (C3-C12)alkylene or (C3-C12)alkenylene with or without a fused ring between adjacent substituents to form an alicyclic ring or aromatic ring; and the alicyclic ring and the aromatic ring may be substituted by any one or more selected from the group consisting of (C1-C10)alkyl, (C1-C10)alkoxy, (C1-C10)alkoxy (C1-C10)alkyl, (C6-C10)aryl, (C6-C10)aryl(C1-C10)alkyl, (C1-C10)alkyl(C6-C10)aryl, (C1-C10)alkylsilyl, and (C6-C10)arylsilyl; and
R¹³ and R¹⁴ are independently of each other (C6-C20)aryl.

4. The transition metal compound of claim 3,
wherein R¹ to R⁴ are independently of one another hydrogen or (C1-C10)alkyl;
R⁵ to R¹² are independently of one another hydrogen, (C1-C10)alkyl, (C1-C10)alkoxy, (C3-C10) cycloalkyl, (C6-C10)aryl, (C6-C10)aryl(C1-C10)alkyl, (C1-C10)alkyl(C6-C10)aryl, (C1-C10)alkylsilyl, or (C6-C10)arylsilyl; or R⁵ to R¹² may be connected by (C3-C12)alkylene or (C3-C12)alkenylene with or without a fused ring between adjacent substituents to form an alicyclic ring or aromatic ring; and the alicyclic ring and the aromatic ring may be substituted by any one or more selected from the group consisting of (C1-C10)alkyl, (C1-C10)alkoxy, (C1-C10)alkoxy (C1-C10)alkyl, (C6-C10)aryl, (C6-C10)aryl(C1-C10)alkyl, (C1-C10)alkyl(C6-C10)aryl, (C1-C10)alkylsilyl, and (C6-C10)arylsilyl; and
R¹³ and R¹⁴ are independently of each other (C6-C10)aryl.

5. The transition metal compound of claim 3,
wherein M is Ti, Zr, or Hf;
A is carbon or silicon;
R¹ to R⁴ are independently of one another hydrogen or (C1-C4)alkyl;
R⁵ to R¹² respectively independently of one another hydrogen, (C1-C4)alkyl, or (C1-C4)alkoxy; and
R¹³ and R¹⁴ are independently of each other (C6-C10)aryl.

6. The transition metal compound of claim 1, wherein the transition metal compound is represented by the following Chemical Formula 1C: 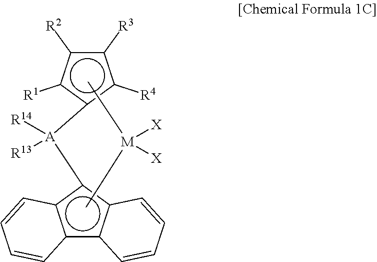
wherein
M is Ti, Zr, or Hf;
A is carbon or silicon;
R¹ to R⁴ are independently of one another hydrogen or (C1-C20)alkyl; and
R¹³ and R¹⁴ are independently of each other (C6-C10)aryl.

7. The transition metal compound of claim 1, wherein the transition metal compound is any one selected from the group consisting of the following compounds:

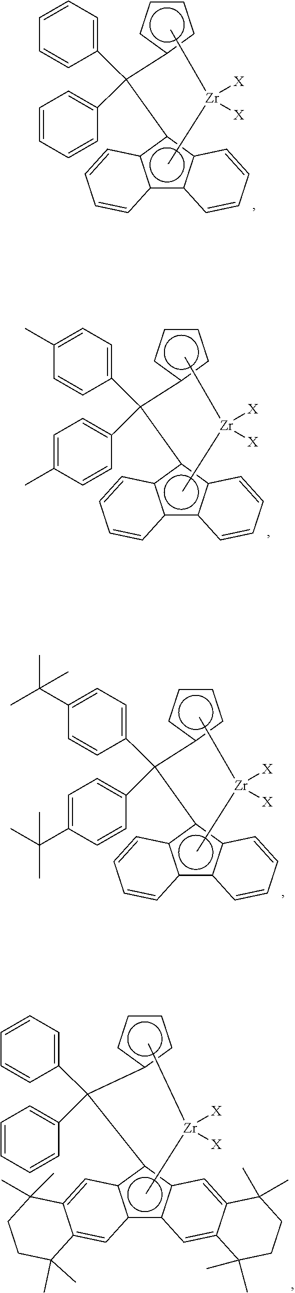

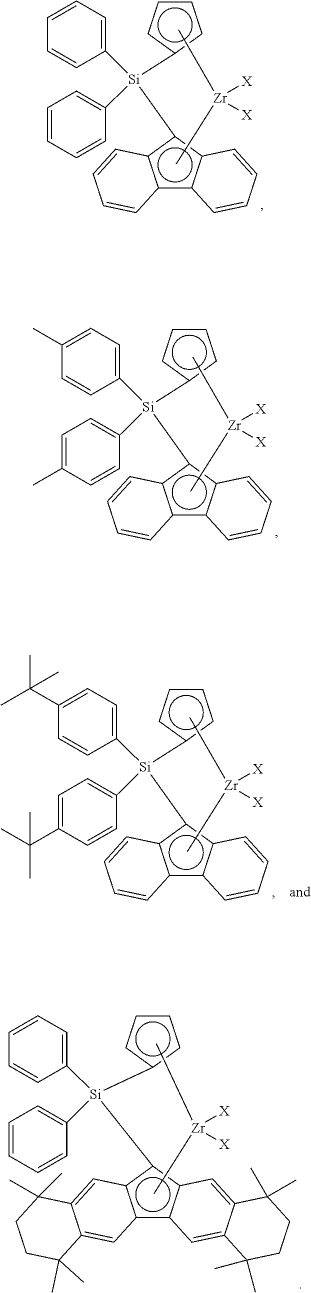

8. The transition metal compound of claim 1, wherein the compound represented by Chemical Formula 2A is any one selected from the group consisting of the following compounds:

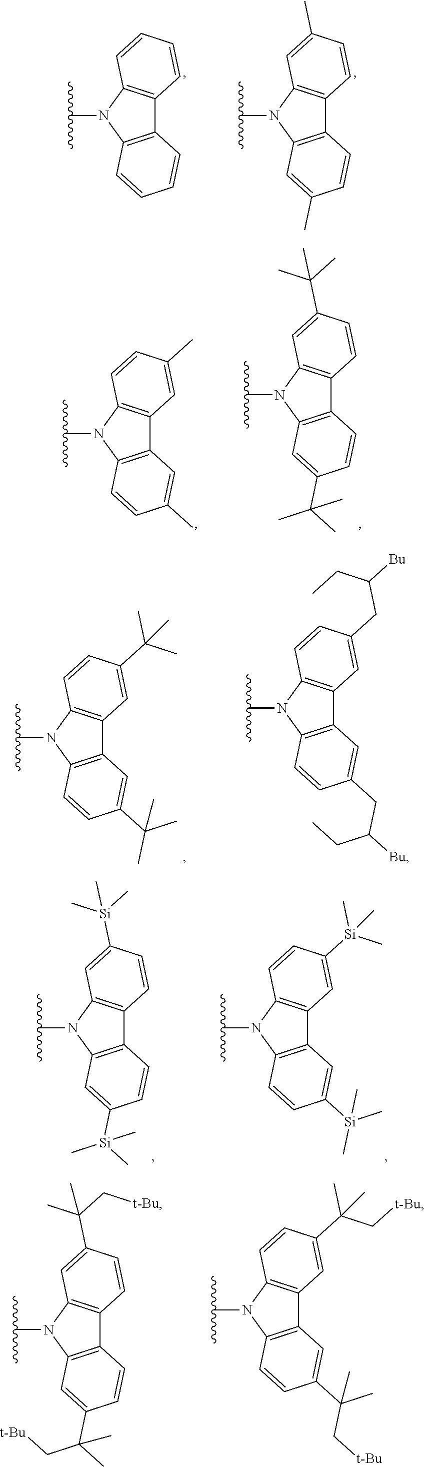

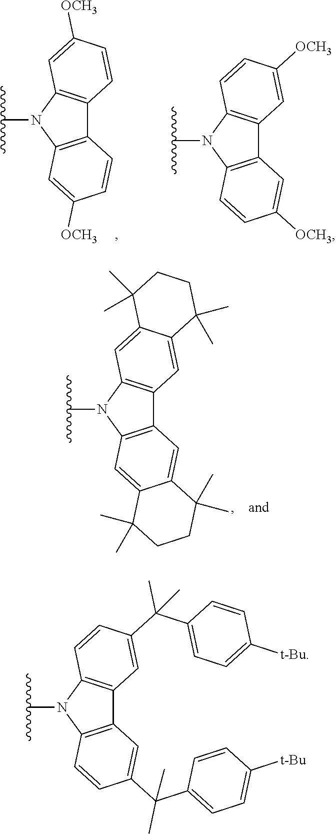

9. The transition metal compound of claim 1, wherein the transition metal compound is

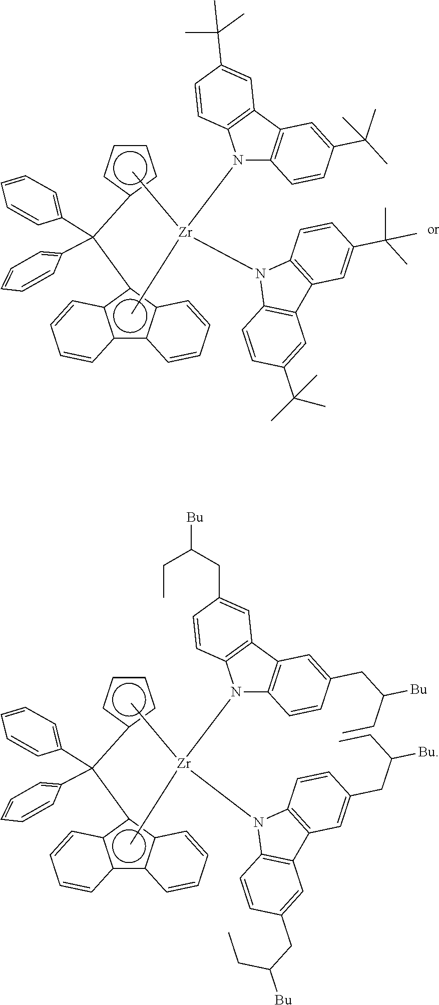

10. The transition metal compound of claim 1, wherein the transition metal compound has a solubility in a hydrocarbon-based solvent at 25° C. of 5 wt % or more.

11. A transition metal catalyst composition for preparing an olefin polymer comprising:
a transition metal compound represented by the following Chemical Formula 1A; and
a cocatalyst: 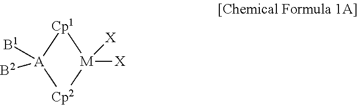
wherein
M is a Group 4 transition metal in the periodic table;
A is carbon or silicon;
Cp¹ and Cp² are independently of each other cyclopentadienyl, indenyl, or fluorenyl; and
the cyclopentadienyl, the indenyl, and the fluorenyl may be substituted by any one or more selected from the group consisting of (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, and (C6-C20)arylsilyl;
B¹ and B² are independently of each other (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, or (C6-C20)arylsilyl; and
X is independently of each other represented by the following Chemical Formula 2A: 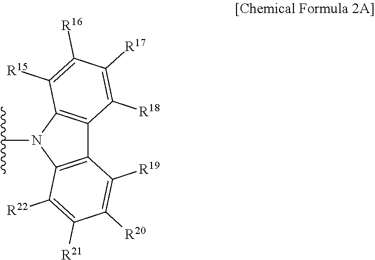
wherein
R¹⁵ to R²² are independently of one another hydrogen, (C1-C30)alkyl, (C1-C30)alkylsilyl, (C1-C30)alkoxy, (C3-C30) cycloalkyl, (C6-C30)aryl, (C6-C30)aryl(C1-C30)alkyl, or (C1-C30)alkyl(C6-C30)aryl; the alkyl, the alkylsilyl, the alkoxy, the cycloalkyl, the aryl, the arylalkyl, and the alkylaryl of R¹⁵ to R²² may be substituted by any one or more selected from the group consisting of halogen, (C1-10)alkyl, (C1-10)alkylamino, (C1-C10)alkoxy, and (C1-C10)alkylsilyl; or R¹⁵ to R²² may be connected by (C3-C12)alkylene or (C3-C12)alkenylene with or without a fused ring between adjacent substituents to form an alicyclic ring or an aromatic ring; and the alicyclic ring and the aromatic ring may be substituted by any one or more selected from the group consisting of (C1-C20)alkyl, (C1-C20)alkoxy, (C1-C20)alkoxy (C1-C20)alkyl, (C6-C20)aryl, (C6-C20)aryl(C1-C20)alkyl, (C1-C20)alkyl(C6-C20)aryl, (C1-C20)alkylsilyl, and (C6-C20)arylsilyl.

12. The transition metal catalyst composition for preparing an olefin polymer of claim 11, wherein the cocatalyst comprises one or more selected from aluminum compounds, boron compounds, and mixtures thereof.

13. The transition metal catalyst composition for preparing an olefin polymer of claim 11, wherein the olefin polymer is an ethylene homopolymer or a copolymer of ethylene and α-olefin.

14. A method for preparing an olefin polymer, the method comprising: subjecting an olefin monomer to solution polymerization under a transition metal compound represented by the following Chemical Formula 1A, a cocatalyst, and a hydrocarbon-based solvent to obtain an olefin polymer. 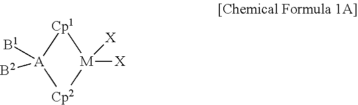
wherein
M is a Group 4 transition metal in the periodic table;
A is carbon or silicon;
Cp¹ and Cp² are independently of each other cyclopentadienyl, indenyl, or fluorenyl; and the cyclopentadienyl, the indenyl, and the fluorenyl may be substituted by any one or more selected from the group consisting of (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, and (C6-C20)arylsilyl;
B¹ and B² are independently of each other (C1-C20)alkyl, (C2-C20)alkenyl, (C1-C20)alkoxy, (C1-C20)alkoxy (C1-C20)alkyl, (C3-C20) cycloalkyl, (C6-C20)aryl, (C6-C20)aryl(C1-C20)alkyl, (C1-C20)alkyl(C6-C20)aryl, (C1-C20)alkylsilyl, or (C6-C20)arylsilyl; and
X is independently of each other represented by the following Chemical Formula 2A: 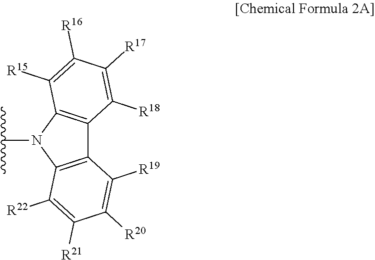
wherein
R¹⁵ to R²² are independently of one another hydrogen, (C1-C30)alkyl, (C1-C30)alkylsilyl, (C1-C30)alkoxy, (C3-C30) cycloalkyl, (C6-C30)aryl, (C6-C30)aryl(C1-C30)alkyl, or (C1-C30)alkyl(C6-C30)aryl; the alkyl, the alkylsilyl, the alkoxy, the cycloalkyl, the aryl, the arylalkyl, and the alkylaryl of R¹⁵ to R²² may be substituted by any one or more selected from the group consisting of halogen, (C1-10)alkyl, (C1-10)alkylamino, (C1-C10)alkoxy, and (C1-C10)alkylsilyl; or R¹⁵ to R²² may be connected by (C3-C12)alkylene or (C3-C12)alkenylene with or without a fused ring between adjacent substituents to form an alicyclic ring or an aromatic ring; and the alicyclic ring and the aromatic ring may be substituted by any one or more selected from the group consisting of (C1-C20)alkyl, (C1-C20)alkoxy, (C1-C20)alkoxy (C1-C20)alkyl, (C6-C20)aryl, (C6-C20)aryl(C1-C20)alkyl, (C1-C20)alkyl(C6-C20)aryl, (C1-C20)alkylsilyl, and (C6-C20)arylsilyl.

15. The method for preparing an olefin polymer of claim 14,
wherein the hydrocarbon-based solvent is one or more non-aromatic hydrocarbon-based solvents selected from the group consisting of methylcyclohexane, cyclohexane, n-heptane, n-hexane, n-butane, isobutane, n-pentane, n-octane, isooctane, nonane, decane, and dodecane; or
one or more aromatic hydrocarbon-based solvents selected from the group consisting of toluene, benzene, ethylbenzene, xylene, naphthalene, methylnaphthalene, anthracene, acenaphthene, and phenanthrene.

16. The method for preparing an olefin polymer of claim 14, wherein a solubility of the transition metal compound in the hydrocarbon-based solvent at 25° C. is 5 wt % or more.

17. The method for preparing an olefin polymer of claim 14, wherein the cocatalyst is selected from aluminum compounds, boron compounds, or mixtures thereof.

18. The method for preparing an olefin polymer of claim 17, wherein the boron compound is selected from compounds represented by the following Chemical Formulae 3A to 3D: 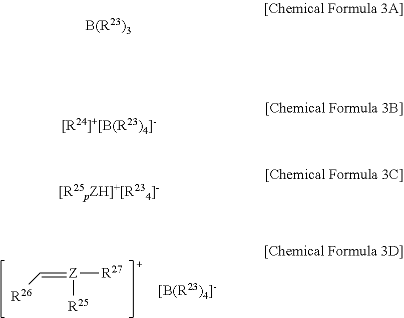
wherein
B is boron;
R²³ is independently of each other phenyl which is unsubstituted or substituted by one or more substituents selected from the group consisting of fluorine, (C1-C20)alkyl, fluorine-substituted (C1-C20)alkyl, (C1-C20)alkoxy, and fluorine-substituted (C1-C20)alkoxy;
R²⁴ is a (C5-C7) aromatic radical, a (C1-C20)alkyl(C6-C20)aryl radical, or (C6-C20)aryl(C1-C20)alkyl radical;
Z is nitrogen or phosphorus;
R²⁵ is independently of each other a (C1-20)alkyl radical or an anilinium radical disubstituted by (C1-C10)alkyl;
R²⁶ is (C5-C20)alkyl;
R²⁷ is (C5-C20)aryl or (C1-20)alkyl(C5-C20)aryl; and
P is 2 or 3.

19. The method for preparing an olefin polymer of claim 17, wherein the aluminum compound is selected from compounds represented by the following Chemical Formulae 4A to 4E: 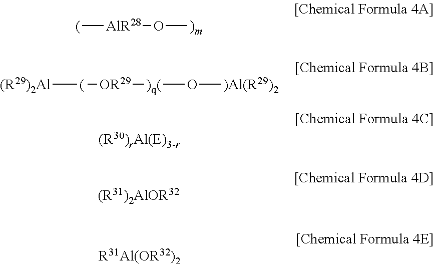
wherein
R²⁸ and R²⁹ are independently of each other (C1-C20)alkyl;
m and q are independently of each other an integer of 5 to 20;
R³⁰ and R³¹ are independently of each other (C1-C20)alkyl;
E is hydrogen or halogen;
r is an integer of 1 to 3; and
R³² is (C1-C20)alkyl or (C6-C30)aryl.

20. The method for preparing an olefin polymer of claim 14, wherein the solution polymerization is performed at a temperature of 100° C. to 200° C.
